(19) United States
(12) Patent Application Publication
(10) Pub. No.: US 2026/0266982 A1
(43) Pub. Date: Sep. 10, 2026

(54) SYSTEM, METHOD, COMPUTER PROGRAM, AND COMPUTER-READABLE MEDIUM

(71) Applicant: FRIEDRICH-ALEXANDER-UNIVERSITÄT ERLANGEN-NÜRNBERG, Erlangen (DE)

(72) Inventors: Johanna BRÄUNIG, Erlangen (DE); Ingrid ULLMANN, Erlangen (DE); Vanessa WIRTH, Abenberg (DE); Björn ESKOFIER, Erlangen (DE); Marc STAMMINGER, Erlangen (DE); Martin VOSSIEK, Fürth (DE)

(21) Appl. No.: 18/875,677

(22) PCT Filed: Jun. 27, 2023
(86) PCT No.: PCT/EP2023/067471

§ 371 Date: Dec. 16, 2024

(30) Foreign Application Priority Data
Jul. 5, 2022 (DE) 10 2022 116 738.0

(51) Int. Cl. G01S 13/86; G01S 13/32; G01S 13/88

(52) U.S. Cl. CPC G01S 13/867; G01S 13/32; G01S 13/88

(57) ABSTRACT

The invention relates to a system for ascertaining a feature of an object. The system comprises a primary module, an assisting module, and a controller, wherein the primary and the assisting module are designed to carry out a respective detection of the feature, generate measurement data with respect to the feature, communicate with the controller which is designed for this purpose, be actuated by the controller which is designed for this purpose, and transmit the measurement data to the controller which is designed for this purpose. The controller has means which are designed to actuate the primary module such that the measurement data generated by the assisting module is taken into consideration, and the controller has means which are designed to ascertain the feature of the object from the totality or from a part of the totality of the generated measurement data.

### CROSS REFERENCE TO RELATED APPLICATIONS

The present application is a U.S. National Phase of International Application No. PCT/EP2023/067471 entitled “SYSTEM, METHOD, COMPUTER PROGRAM, AND COMPUTER-READABLE MEDIUM,” and filed on Jun. 27, 2023. International Application No. PCT/EP2023/067471 claims priority to German Patent Application No. 10 2022 116 738.0 filed on Jul. 5, 2022. The entire contents of each of the above-listed applications are hereby incorporated by reference for all purposes.

### TECHNICAL FIELD

The present invention relates to a system for ascertaining a feature of an object.

### BACKGROUND AND SUMMARY

The prior art is formed by the following publications.
[1] H. Klausing and W. Holpp, Radar mit realer und synthetischer Apertur [Radar with real and synthetic aperture], Boston: Oldenbourg Wissenschaftsverlag, 2010.
[2] M. Younis, C. Fischer and W. Wiesbeck, “Digital beamforming in SAR systems,” IEEE Transactions on Geoscience and Remote Sensing, pp. 1735-1739, August 2003.
[3] S. S. Ahmed, A. Schiessl and L. Schmidt, “A Novel Fully Electronic Active Real-Time Imager Based on a Planar Multistatic Sparse Array,” IEEE Transactions on Microwave Theory and Techniques, vol. 59, no. 12, pp. 3567-3576, 2011.
[4] E. Fishier, A. Haimovich, R. Blum, D. Chizhik, L. Cimini and R. Valenzuela, “MIMO radar: an idea whose time has come,” Proceedings of the 2004 IEEE Radar Conference, pp. 71-78, 2004.
[5] A. M. Haimovich, R. Blum and L. Cimini, “MIMO Radar with widely separated antennas,” Signal Processing Magazine, IEEE, vol. 25, pp. 116-129, 2008.
[6] M. Göttinger, M. Hoffmann, M. Christmann, M. Schütz, F. Kirsch, P. Gulden and M. Vossiek, “Coherent Automotive Radar Networks: The Next Generation of Radar-Based Imaging and Mapping,” IEEE Journal of Microwaves, no. 1, pp. 149-163, 2021.
[7] Chen, V. C., “Detection and analysis of human motion by radar,” 2008 IEEE Radar Conference, pp. 1-4, 2008.
[8] S. Björklund, H. Petersson, A. Nezirovic, M. B. Guldogan and F. Gustafsson, “Millimeter-wave radar micro-Doppler signatures of human motion,” 2011 12th International Radar Symposium (IRS), pp. 167-174, 2011.
[9] S. Z. Gurbuz and M. G. Amin, “Radar-Based Human-Motion Recognition With Deep Learning: Promising Applications for Indoor Monitoring,” IEEE Signal Processing Magazine, vol. 36, no. 4, pp. 16-28, 2019.
[10] Y. Dobrev, “Radar-Verfahren und -System zur Bestimmung der Winkellage, des Ortes und/oder der, insbesondere vektoriellen, Geschwindigkeit eines Zieles”. [Radar methods and systems for determining the angular position, the location, and/or the, in particular vectorial, velocity of a target.] German Patent EP 3 470 874 A1, 11 10 2018.
[11] J. A. Nanzer, “Millimeter-Wave Interferometric Angular Velocity Detection,” IEEE Transactions on Microwave Theory and Techniques, vol. 58, no. 12, pp. 4128-4136, 2010.
[12] C. Schüßler, M. Hoffmann, R. Ebelt, I. Weber and M. Vossiek, “Position and Velocity Fusion Using Multiple Monostatic Radar Sensors for Automotive Applications,” 2021 IEEE Radar Conference (RadarConf21), pp. 1-6, 2021.
[13] M. Zhao, Y. Tian, H. Zhao, M. A. Alsheikh, T. Li, R. Hristov, Z. Kabelac, D. Katabi and A. Torralba, “RF-based 3D skeletons,” Proceedings of the 2018 Conference of the ACM Special Interest Group on Data Communication (SIGCOMM '18), pp. 267-281, 2018.
[14] T. S. Ralston, G. L. Charvat and J. E. Peabody, “Real-time through-wall imaging using an ultrawideband multiple-input multiple-output (MIMO) phased array radar system,” 2010 IEEE International Symposium on Phased Array Systems and Technology, pp. 551-558, 2010.
[15] F. Adib, C. Hsu, H. Mao, D. Katabi and F. Durand, “Capturing the human figure through a wall,” ACM Trans. Graph., vol. 34, no. 6, 2015.
[16] Z. Xiong, Y. Zhang, F. Wu and W. Zeng, “Computational Depth Sensing: Toward high-performance commodity depth cameras,” IEEE Signal Processing Magazine, vol. 3, May 2017.
[17] M. Zollhöfer, P. Stotko, A. Görlitz, C. Theobalt, M. Nießner, R. Klein and A. Kolb, “State of the Art on 3D Reconstruction with RGB-D Cameras,” Computer Graphics Forum, no. 37, 2018.
[18] J. Wang, T. Karp, J. Munoz-Ferreras, R. Gomez-Garcia and C. Li, “A Spectrum-Efficient FSK Radar Technology for Range Tracking of Both Moving and Stationary Human Subjects,” IEEE Transactions on Microwave Theory and Techniques, vol. 67, no. 12, pp. 5406-5416, 2019.

Radar assemblies and methods for imaging objects are known in a wide range of forms from the prior art. Almost all methods for radar-based reconstruction of an image of surroundings, a scene or an object are based on a plurality of measuring signals, which were generated by the use of a plurality of transmitting and/or receiving locations, are superimposed in phase in an algorithm. Known radar-based reconstruction methods of the multiple-input multiple-output (MIMOP) radar systems, the synthetic aperture radar, the holography, the tomography, etc. are found for example in [1] and [2], MIMO radars comprising a plurality of transmitting and receiving antennas allow, with corresponding digital radar-based image reconstruction methods, a high resolution and a precise direction estimation, as is known from [3], [4], [5], [6].

In the above-mentioned works, it is generally assumed that the detected scenery is static or at least virtually static. Virtually static means that the detect scenery moves only a little during the recording of the measurement data that are necessary for a radar-based image reconstruction, such that no significant interference occurs in the radar-based image reconstruction.

If the objects to be imaged are moving, an image can be reconstructed by means of inverse synthetic aperture radar (ISAR). A prerequisite for ISAR imaging is, however, that the relative movement between the radar and object is known or estimated with a high degree of accuracy.

In order to be able to quickly detect dynamic movements, the individual measurements must take place very quickly. Using conventional imaging MIMO radar technology, it is possible only with great difficulty to achieve such a high measuring rate for it to be possible to track dynamic movements continuously from image to image. When using broadband radar measuring signals or a plurality of different radar measuring frequencies and a plurality of transmitting and receiving antennas, both the measuring process and the radar-based image reconstruction are extremely time-consuming. One reason for this is that it is possible only with great difficulty to find a plurality of broadband transmission signals which are all uncorrelated and thus allow for simultaneous transmission of all the transmitting antennas. Consequently, in MIMO radar technology, in particular in the case of large MIMO arrays, frequently what is known as time division multiplexing is used, in which all the transmitters transmit in succession. This can inherently lead to slowed measurements and to movement artefacts in the radar-based image reconstruction. The real-time capable detection of body shells using radar fails when time division multiplexing is used in combination with larger MIMO arrays which, however, are necessary for high-resolution imaging, also generally in addition at the time when the signal decorrelation and the radar-based image reconstruction would take place.

Various methods for detecting movements of objects are also known from the field of radar technology, which methods are not based on high-resolution imaging of the shell, but rather evaluate the Doppler signature in the radar signals, in order to detect movements. In particular for detecting human movements and also for the reconstruction of body poses, various methods are known from the prior art.

Movement profiles of a person consist of a plurality of individual movements. In addition to the movement of the torso, which is reflected in the radar signal as Doppler signal components, the additional movement of the arms and legs, as well as the fingers, also results in weaker Doppler signals, which are referred to as micro-Doppler, as follows from [7]. Micro-Doppler signatures are used for example for the classification and identification of specific movements, frequently based on machine-learning algorithms. This is disclosed in [8] and [9]. However, the works mentioned aim merely to separate or classify body parts or movements, but hitherto contain no imaging.

In the case of a Doppler velocity estimation, in general only the radial component of the velocity is evaluated. The determination of the vectorial velocity is significantly more challenging. Here, spatially distributed transmitting/receiving units are used, and in the case of scenes having differently moving partial structures complex algorithms are used, as is described for example in [10], [11] and [12].

In [13], 3D avatars of humans were reconstructed from FMCW radar measurement data by means of an artificial neural network, from few measurement points. The phased array system for imaging human movement was set out in [14]. This system allows for live tracking of a person, but not for spatially resolved imaging. In [15], a radar system is set out which can record and reconstruct image data sequentially, at a frame rate of 12.5 Hz. Spatially and temporally resolved information on movement sequences is obtained from a priori knowledge of the sequence of movement patterns and associated reflection behaviour of individual body regions. However, the works mentioned contain neither high-resolution imaging of the human body, nor direct measurement of the velocities distributed on the body surface.

In optical imaging technology, likewise a plurality of different methods for detecting the shell of objects is known. Known preprocessing methods are found in [16] and further referenced works.

In known optical measuring systems, such as depth cameras, these methods are already integrated into the sensor. Optical measuring systems detect the shell of objects at a very high spatial resolution. However, this resolution, similarly to the human eye, is limited by the field of view of the measuring system. Therefore, postprocessing approaches also take place, usually on the basis of the generated data, for completing and/or improving the detected shell. Known approaches for this are found in [17].

A further disadvantage of optical measuring systems is that these do not deliver any direct additional velocity information within the preprocessing, and therefore are configured only for static or at least quasi static objects.

In order to nonetheless be able to determine a movement, e.g. of a shell, postprocessing algorithms are additionally used, on the basis of the generated data of the optical measuring system. If no further assumptions can be made relating to the visible object, in this case these algorithms usually estimate the movement of the shell by temporally tracking the successive generated spatial points. Here, too, known approaches are found in [17]. The accuracy of this tracking depends substantially on the ratio of the velocity of the moving object to the measuring rate of the optical measuring system.

Against this background, the problem addressed by the present invention is that of providing a system for optimised detection of a feature of an object.

This problem is solved by the subject matter having the features of independent claim 1. The dependent claims relate to advantageous developments of the invention.

According thereto, it is provided according to the invention that the system has a primary modality, an assisting modality, and a controller, wherein the primary and the assisting modality are configured to in each case detect the feature, generate measurement data with respect to the feature, communicate with the controller which is configured for this purpose, be actuated by the controller which is configured for this purpose, and transmit the measurement data to the controller which is configured for this purpose, wherein the controller has means which are configured to actuate the primary modality such that the measurement data generated by the assisting modality are taken into consideration, and the controller has means which are configured to ascertain the feature of the object from the totality or from a part of the totality of the generated measurement data.

It is preferably provided that the feature of the object relates to the shell of the object and/or that the object is a living creature and/or that the feature of the object is a position, velocity and/or acceleration of a region of the object or the shell of the object, and/or an item of phase information of a wave reflected from a region of the object or of the shell of the object.

A controller is preferably understood to be any means, such as a circuit or a computer, which is configured to perform the functions attributed to the controller or to a means of the controller within this invention. A controller is therefore preferably to be interpreted broadly, and for example also includes a regulating means.

It is conceivable for the controller to comprise means for inputting, displaying and/or outputting, in particular of the ascertained feature of the object.

It is preferably provided that the controller comprises means which are configured to store the measurement data.

It can preferably be provided that the controller comprises means which are configured to compare a plurality of ascertained features and/or generated measurement data and to thereby determine a comparative value from which a further feature, in particular a position, a velocity and/or an acceleration, is derived.

In an advantageous embodiment it is provided that the primary modality comprises a radar system having at least one transmitting antenna and at least one receiving antenna, wherein preferably means are present which are configured such that waves having fewer than 10, preferably having precisely one, two or three, different frequency sampling points are transmitted by a transmitting antenna, and/or that the assisting modality comprises a, preferably three-dimensional, imaging sensor. Frequency sampling points can also be referred to as frequencies and preferably describe the temporal succession of just one or a plurality of transmission frequencies.

It is conceivable that the antennas of the radar system form a MIMO aperture, wherein means are present which are configured for generating a laterally focused image of the object by aperture synthesis.

It is furthermore conceivable that the primary modality comprises a CW, stepped-frequency and/or frequency-shift keying radar system.

It is preferably provided that the assisting modality comprises an optical measuring system, in particular a camera, a depth camera, a stereo camera or a laser scanner.

It is preferably provided that the controller comprises means which are configured to optimise the ascertainment of the feature of the object by means of features and/or measurement data.

It can be provided that the controller comprises means which are configured to use a static filter, preferably a Kalman filter, a movement model, and/or a method known from information technology, and/or that the means are configured such that a vectorial velocity measurement takes place.

It can be provided that the system is a component of a sport, training or fitness measuring or fitness information system, that the system is used for a medical, psychological, diagnostic or therapeutic purpose and/or is used for generating digital human avatars. The invention also relates to a method for ascertaining a feature of an object using a system according to the invention, having the steps of:
a) detecting the feature by means of the assisting modality, and generating measurement data with respect to the feature;
b) detecting the feature by means of the primary modality, wherein the primary modality is actuated by the controller in such a way that the measurement data generated in step a) are taken into account, and generating measurement data with respect to the feature;
c) ascertaining the feature from the measurement data.

It is preferably provided that the feature of the object relates to the shell of the object and/or the object is a living creature and/or that the feature of the object is a position, velocity and/or acceleration of a region of the object or the shell of the object, and/or an item of phase information of a wave reflected from a region of the object or of the shell of the object.

It is conceivable that the generated measurement data are stored.

It is conceivable that the method is performed again, wherein the ascertained feature and/or the generated measurement data from the first performance is compared with the ascertained feature and/or with the generated measurement data from the second performance, and wherein as a result a comparative value is determined, from which a further and/or improved feature, in particular a position, a velocity and/or an acceleration, is derived.

It is furthermore conceivable that the primary modality transmits waves having fewer than 10, preferably having precisely one, two or three, different frequency sampling points, from a transmitting antenna.

It is preferably provided that the method comprises a further step, in particular an aperture synthesis, wherein a laterally focused image of the object is generated.

It can be provided that the method is performed again and a feature and/or measurement data from a preceding performance are used for optimising the performance.

It is preferably provided that in the method a static filter, preferably a Kalman filter, a movement model, and/or a method known from information technology is used, and/or that a vectorial velocity measurement takes place.

It is preferably provided that the method is used in a sport, training or fitness measuring or fitness information system, or for a medical, psychological, diagnostic or therapeutic purpose, and/or for generating digital human avatars.

The invention also relates to a computer program which comprises commands which cause the system according to the invention to perform the method steps of a method according to the invention.

The invention also relates to a computer-readable medium, on which the computer program according to the invention is stored.

A multimodal assembly for detecting the shell of a body of living creatures, in particular the body shell of humans, and for determining temporal movements of the shell, is preferably proposed. Associated advantageous methods for operating the assembly and for detecting the shell and its movements are also explained.

An assembly for detecting the body shell of a living creature can also be provided, wherein the assembly has a primary sensor modality, which contains a radar system having at least one transmitting antenna and at least one receiving antenna, the assembly has a further assisting three-dimensionally imaging sensor modality, and in a first step an at least rough spatial and distance region is determined by the assisting sensor system, in which region at least one point of the shell to be detected is located, and in a second step an image of said at least one point of the shell is reconstructed by the primary sensor modality, using at least one radar signal frequency.

It can be provided that, in a third step, the image of said at least one reconstructed point is compared, with respect to phase, with its image from a preceding measurement, and a phase difference value is determined from this, and a movement feature is derived from the phase difference value.

It can furthermore be provided that the primary sensor modality is configured as CW, stepped-frequency and/or frequency-shift keying radar, and only a small number, preferably a number smaller than 10, particularly preferably only 1, 2 or 3, different radar signal frequency sampling points are used per transmitting antenna in a measurement.

It can also be provided that the primary sensor modality is equipped with a plurality of transmitting antennas and a plurality of receiving antennas, and the antennas form a MIMO aperture and this aperture is used in the sense of aperture synthesis to reconstruct a laterally focused image from points of the shell.

It can furthermore be provided that the rough spatial and distance region in which at least one point of the shell of the object to be detected is located is determined by an optical measuring system, in particular by a depth camera, a stereo camera or a laser scanner.

It can also be provided that, in addition to the first radar signal frequency, at least one further radar signal frequency is used for imaging said at least one point of the shell, and the phases of the images which were acquired with the first and with at least one further radar signal frequency are compared with respect to the phase values, and a distance value of at least one point of the body shell is derived from at least one phase difference value obtained in this way.

An iterative process can be provided, in which a use of the location and velocity information of at least one preceding measurement takes place for improving the representation or the image of the shell and for improved determination of the movement thereof.

The use of static filters, such as Kalman filters or the like, the use of movement models, and/or an improvement of the methods known in information technology can be provided.

It is likewise conceivable for a vectorial velocity measurement to take place.

A sensor fusion of a depth camera and radar can also take place.

A system, an assembly or a method is conceivable by means of which the body shell of a living creature, preferably the body shell of a human, or the temporal movement of the body shell is determined metrologically, and at least one result of this measurement is used for a medical, psychological, diagnostic or therapeutic purpose.

An assembly is furthermore conceivable by means of which the body shell of a living creature, preferably the body shell of a human, or the temporal movement of the body shell is determined metrologically, and at least one result of this measurement is used in a sport, training or fitness measurement or fitness information system.

An assembly is furthermore conceivable by means of which the body shell of a living creature, preferably the body shell of a human, or the temporal movement of the body shell is determined metrologically, and at least one result of this measurement is used in for creating a digital human avatar.

The present invention overcomes many of the limitations present in the prior art. The invention also relates to an assembly and advantageous method for operating the assembly for high-precision, contactless detection of the shell of an object and of the velocity vector of one, a plurality of, or each point on said shell. For this purpose, preferably a primary radar-based modality is combined with an assisting 3D-imaging modality, and the strengths of the sensors are combined. The shell and its movements are thereby preferably detected with comparatively little outlay and a high spatial resolution capacity and excellent velocity accuracy of all three spatial directions in each case, and at a high measuring rate.

It is preferably irrelevant for the invention as to which radar-based reconstruction method is used. It is also preferably irrelevant for the invention as to which optical reconstruction method is used.

The term shell or body shell is preferably to be understood as the boundary surface or the sum of a plurality of coupled boundary surfaces, which, in the case of a body of a living creature, creates the boundary between inside and outside. Outside is generally air or the atmosphere surrounding the living creature, and inside is preferably the body or the material structures of the body.

In the case of many animals and in the case of humans, the shell or the body shell can preferably be defined by the skin surface, wherein, however, this is just one possible definition, since it may be expedient, depending on the application, to include or not to include the clothing, hair, dirt or other adhesions on the body, or other objects firmly connected to the body.

Preferably, the shell is also a shell of another object delimited by a shell. In this connection, in particular humanoid robots or bio-inspired robots, i.e. robots inspired by other living creatures, or also handing or manufacturing robots, could be cited. Technical mobile systems, in particular motor vehicles, transport systems, construction machines, and mobile robots, preferably also comprise a shell, wherein the bodywork or the chassis typical form the shell.

The detection of the shell is preferably to be understood as a metrological process in which the geometric course of the shell is determined. In particular, the detection process is preferably an imaging process, in which an image of the shell which is as geometrically correct as possible is created. For this purpose, the spatial positions of a plurality of points of the shell are preferably determined, and at least some points, but preferably all the points, of this set of points, are also associated with further features, for example particular reflectivity properties, such as the strength of the reflection, the frequency-dependency of the reflection, referred to in the optical field as colour, or the polarimetric reflection behaviour. The detection of the shell preferably also includes the determination of the positions of the shell points relative to a reference coordinate system.

If movements of the shell of a body or object are determined, then at least some points of the above-mentioned set of points are also associated with at least one movement feature. A movement feature can be a scalar velocity, a vectorial velocity, a one-dimensional or multi-dimensional acceleration variable, or also a higher order complex multi-dimensional motion equation.

The detection of the shell and/or the determination of the movement of said shell are preferably divided into two categories: preprocessing and postprocessing. These differ in terms of the data pool used.

The preprocessing works on the data which are generated directly from one or more sensors or modalities. The preprocessing generates a preliminary, application-related data pool. In the detection of the shell, the preprocessing generates a preliminary geometric course of the shell. In the determination of the movement of the shell, the preprocessing generates preliminary movement features.

The postprocessing is, as the name suggests, to be arranged temporally after the preprocessing, and expands the preliminary data pool with further information. This can for example be a correction or a completion of the data hitherto. Postprocessing with respect to the detection of the shell can e.g. recalculate or adjust the previously determined geometric course, such that this even better approximates the real shell. In particular, a postprocessing can also serve for completing the shell which could be determined only in part in preprocessing, since e.g. the back of an object could not be determined owing to shading of the sensor means used. The postprocessing for determining the movement of the shell can also serve to correct or refine the preliminary movement features. In particular, it can expand the preliminary movement features, associated with a set of points, with a further set of points comprising movement features, if the postprocessing for determining the movement of the shell is combined e.g. with a postprocessing for detecting the shell.

Preferably the detection of the body shell and its movement should take place by means of at least two different wave-based sensor modalities and the sensor data fusion thereof. A wave-based sensor modality is preferably to be understood as a measuring assembly which uses a waveform for detecting measuring information, e.g. the detection of an image of a body.

Electromagnetic waves, for example in the microwave or in the optical range, or sound/ultrasound waves are possible as the waveform. The modality is preferably defined here such that a modality can be distinguished both by the waveform, e.g. radar or optical or ultrasound, and also by the measuring principle, e.g. narrow-band CW or N-FSK radar, or broadband FMCW or FSCW radar.

As a preferred multimodal embodiment, preferably a combination of at least one radar-based modality or a primary modality with at least one further assisting modality is proposed. Preferably a three-dimensionally imaging wave-based modality, in particular a three-dimensional optical imaging technique, preferably performed using a depth camera, a stereo camera or a laser scanner, is proposed as the assisting modality. However, a broadband radar system can also be used as the assisting modality, which system, however, then differs from the primary radar-based modality in that it delivers three-dimensional, high-resolution imaging in each measuring cycle and is significantly more complex, and in particular can measure significantly more slowly, than the primary modality. Imaging FMCW, FSCW, OFDM or pulse radar are also possible, as they are known from the prior art, are possible as the assisting radar modality. In contrast, the primary radar modality is preferably configured such that it is optimised to detect dynamic movements.

The primary radar modality is preferably a narrow-band continuous-wave (CW) radar or what is known as stopped-frequency radar (FSCW/SFCW), or an FSK or N-FSK radar. Preferably, the radar is configured as multiple-input multiple-output (MIMO) radar having a plurality of transmitting and receiving antennas. Preferably, only a small number of, preferably only a number less than 10, different frequency sampling points are emitted via a transmitting antenna, in particular however just one frequency sampling point, as in the case of a CW radar, just 2 different frequency sampling points, as in the case of a 2-FSK radar, or just 3 different frequency sampling points, as in the case of a 3-FSK radar. The primary radar modality therefore preferably has a good lateral resolution, i.e. viewed perpendicularly to the wave propagation direction, which resolution is determined by the number of transmitting antennas and receiving antennas and/or the size of the resulting synthetic aperture, and preferably only a limited, or even no, axial resolution in the distance direction, i.e. in the wave propagation direction. The ability of being able to separate different targets in the distance direction, i.e. the axial resolution, is preferably determined by the bandwidth of the radar signals used. Since a high signal bandwidth, in particular in the case of MIMO radar systems, can make the measuring process complicated and in particular can slow the measuring process, in the case of the primary radar modality preferably a large bandwidth and thus also a good resolution in the distance direction and thus also the ability of creating good three-dimensional images, are intentionally omitted.

Depending on the sensor means or modality used, the general approach to the reconstruction of the imaging of objects also differs. Therefore, preferably explicitly all reconstruction methods for an optical measuring system, which are preferably also referred to as optical reconstruction methods or optical reconstruction, are delimited, terminologically, from all reconstruction methods for a radar-based measuring system, preferably referred to as radar-based reconstruction methods or radar-based reconstruction.

At this point, it is noted that the terms “a” and “an” do not necessary refer to exactly one of the elements, even if this is a possible implementation, but rather can also refer to a plurality of the elements. Likewise, the use of the plural also does not exclude the presence of the element in question in the singular, and, vice versa, the singular also includes a plurality of the elements in question. Furthermore, all the features of the invention described herein can be claimed in any desired combination with one another or in isolation from one another.

Further advantages, features and effects of the present invention emerge from the following description of preferred embodiments with reference to the figures, in which identical or similar components are denoted by the same reference signs. In the figures:

### BRIEF DESCRIPTION OF THE FIGURES

FIG. 1: shows an embodiment of a system according to the invention.

FIG. 2: shows a further embodiment of possible structures of the modalities of a system according to the invention.

FIG. 3: shows an embodiment of a possible manifestation of the modalities of a system according to the invention.

FIG. 4: shows a further embodiment of a system according to the invention.

FIG. 5: shows two matrices with phase information or image phases per pixel.

FIG. 6: is a flow diagram of a preferred method.

### DETAILED DESCRIPTION

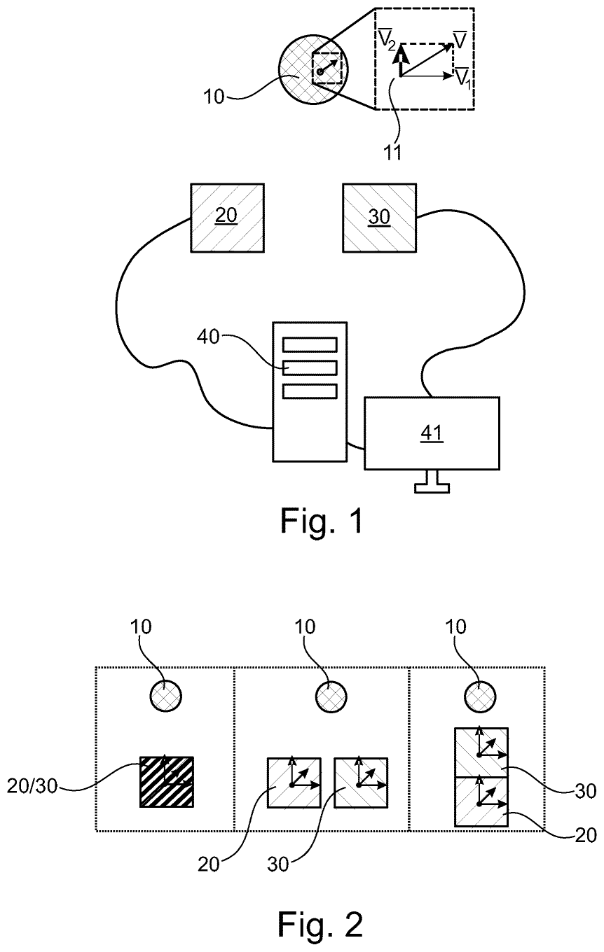

FIG. 1 shows the combination of a primary modality 20 with an assisting modality 30 for determining the shell of an object 10, and the movement thereof.

The object moves in FIG. 1 with a velocity vector V having reference sign 11, which can for example be broken down into the cartesian components V₁ and V₂.

In this case, the velocity vector V can also be a three-dimensional vector, which can be broken down into three cartesian components.

The primary modality 20 and the assisting modality 30 are connected to a computer 40, which can be connected to a monitor 41, on which computer algorithms for imaging and movement determination of the object 10 are executed.

In this case, in particular the individual orientations of the two modalities 20 and 30 are correlated with one another.

The modalities 20 and 30 can for example be correlated using the structures shown in FIG. 2. The modalities 20 and 30 detect the object 10 to be recorded. The orientations are, as also in the following figures, not illustrated by the mentioned coordinate systems.

In the structure shown on the left-hand side of FIG. 2, the two modalities 20 and 30 are installed in one another and therefore have, a priori, a common orientation, i.e. one that is known at least relative to one another. Alternatively, the two modalities 20 and 30 can be placed offset, and the relative orientation with respect to one another can thereupon be calculated. For example, the modalities 20 and 30 can be offset side-by-side, as can be seen from the structure shown in the centre in FIG. 2. Likewise, the modalities 20 and 30 can be oriented so as to be offset one above the other, as can be seen from the right-hand structure from FIG. 2. In this case, side-by-side and one above the other preferably relates to the alignment with respect to the object 10.

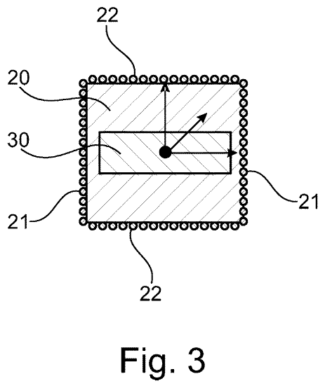

In this case, a combination of an imaging MIMO FSK radar as the primary modality 20 with a depth camera as the assisting modality 30, which are installed in one another, is preferred, as follows from FIG. 3. In this case, the MIMO FSK radar or the primary modality 20 preferably comprises receiving antennas 21 and transmitting antennas 22. In this case, the two modalities 20 and 30 are preferably placed in such a way that their generated data overlap as extensively as possible, temporally and spatially, such that they can be merged and combined with one another as precisely as possible.

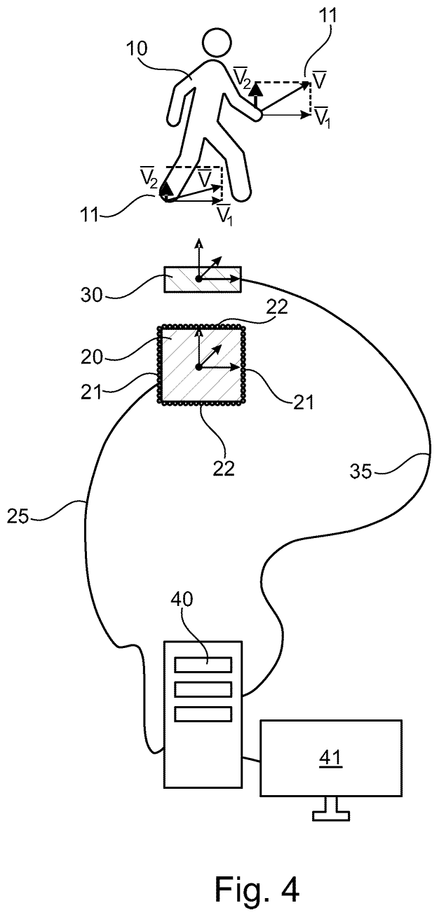

FIG. 4 now shows an imaging MIMO FSK radar as the primary modality 20 with a depth camera as the assisting modality 30, which are oriented so as to be offset one above the other. In this case, the MIMO FSK radar or the primary modality 20 preferably comprises receiving antennas 21 and transmitting antennas 22.

The object 10 in FIG. 4 is for example a moving person or a body part. Individual points of the person or the body part move in FIG. 4 in each case with a velocity vector V having reference sign 11, which can for example be broken down into the cartesian components V₁ and V₂.

The depth camera or the assisting modality 30 is connected to a computer 40 by a connection 35 via which distance features of the object 10, detected by the depth camera or the assisting modality 30, can be transmitted.

The MIMO FSK radar or the primary modality 20 is connected to the computer 40 by a connection 25 via which velocity and distance features of the object 10, detected by the MIMO FSK radar or the primary modality 20, can be transmitted.

The computer 40 can be connected to a monitor 41, on which the results of the algorithms, executed on the computer 40, for imaging and movement determination of the object 10 can be displayed.

Without further combining of the individual modalities 20 and 30, these initially provide the following data.

The primary modality 20 firstly delivers the radial velocity, by evaluating temporally varying phase information. Above all continuous wave (CW) signals are possible here as suitable signals. These can either consist only of one, or also of a plurality, of frequency sampling points. In the case of use of just one CW frequency, velocities and relative distance changes can be measured. Owing to the periodicity of the phase, wherein each period runs in each case from 0 to 360°, absolute distances can be determined in a comparatively small clarity range only when the relevant period or the relevant focus range representing said period is known.

In the case of signals having a plurality of frequency sampling points, in addition an absolute distance measurement having a large clarity range. In particular in the case of the preferred configuration of the primary modality 20 in the form of an FSK MIMO radar, which uses at least two frequency sampling points, an image of the recorded shell of the object 10 is measured. In addition, the locally distributed velocity of said shell can be ascertained by a suitable preprocessing method. In the simplest case, this can be a comparison of the consecutive radar images. Either the evaluation of the complex phase of consecutive images, or the evaluation of the continuous change in the receiving phases, is preferred.

In addition, the assisting modality 30 initially delivers spatially resolved distance data of the recorded shell of the object 10. In this case, the reconstruction method by means of which these distance data are generated is preferably irrelevant.

By combining the initially isolated modalities, for example referred to as sensor data fusion, new, more comprehensive data can be achieved at a greater degree of accuracy. However, postprocessing methods, which are used for complete detection of the shell of the object 10, can also be applied more quickly and more efficiently in this way.

As a first step of the sensor data fusion, the detected object 10 is located roughly in space, by the assisting modality 30, and thereby the region is defined in which the shell of interest is located. Building on this, in this region a radar-based reconstruction according to a known method is performed. In this case, the restriction of the radar-based reconstruction to selected points in the relevant region significantly accelerates the processing speed of the radar-based reconstruction. In addition, the locating of the object 10, which has already taken place, allows for the use of narrow-band radar signal forms, which have no or only a very low, range resolution. The generation thereof can take place much more quickly compared with the broadband signal forms used hitherto in radar imaging, and is therefore advantageous in the case of time-critical applications.

If the primary modality 20 uses at least two frequency sampling points, then in addition to the existing data of the assisting modality 30, spatially resolved images of the shell can also be generated.

In addition to known methods, a new approach based on two frequency sampling points is preferably used.

In this new approach, the approach of the frequency-shift keying, as is known from [18], is combined with the radar imaging methods conventional hitherto. The disclosure of [18] is hereby incorporated in its entirety in the present description.

Based on the first rough locating by the assisting modality 20, two two-dimensional images of the shell are reconstructed, according to known methods, at the distance estimated by the assisting sensor system or modality 20, or the z-coordinate dₛ, using two closely adjacent frequencies f₁, f₂. The starting point for the reconstruction is provided by the two CW baseband signals s_{b,f1} and s_{b,f2}, which were detected at the two frequency sampling points f₁ and f₂ using a transmitting antenna at the location \vec{x}ₜₓ and a receiving antenna at the location \vec{x}ᵣₓ, and were caused by a point scatterer at the location \vec{x}ₛ. The following formulas show a possibility of how the CW baseband signals can be ascertained.

$${s}_{b 1} = exp ( j 2 π {f}_{1} \frac{2 d}{c} + {ϕ}_{rx} )$$

$${s}_{b 2} = exp ( j 2 π {f}_{2} \frac{2 d}{c} + {ϕ}_{rx} )$$

$$mit d = \vert \vert {\vec{x}}_{tx} - {\vec{x}}_{s} \vert \vert + \vert \vert {\vec{x}}_{rx} - {\vec{x}}_{s} \vert \vert$$

In this case, c is the speed of light. The two hypotheses which result for the two frequency sampling points and over the estimated distance dₛ are reproduced by the two following formulas.

$${s}_{H , f 1} = exp ( j 2 π {f}_{1} \frac{2 {d}_{s}}{c} )$$

$${s}_{H , f 2} = exp ( j 2 π {f}_{2} \frac{2 {d}_{s}}{c} )$$

The estimated distanced dₛ is the sum of the real distance d and an either positive or negative difference distance Δd. This results in the hypotheses as are shown in the two following formulas.

$${s}_{H , f 1} = exp ( j 2 π {f}_{1} \frac{2 d \pm Δ d}{c} )$$

$${s}_{H , f 2} = exp ( j 2 π {f}_{2} \frac{2 d \pm Δ d}{c} )$$

In the case of a correlation of the baseband signals with the complexly conjugated hypothesis according to the known methods for checking the signal hypothesis, the two correlation signals result, as shown in the two following formulas.

$${s}_{korr , f 1} = exp ( j 2 π {f}_{1} \frac{\pm Δ d}{c} + {ϕ}_{rx} )$$

$${s}_{korr , f 2} = exp ( j 2 π {f}_{2} \frac{\pm Δ d}{c} + {ϕ}_{rx} )$$

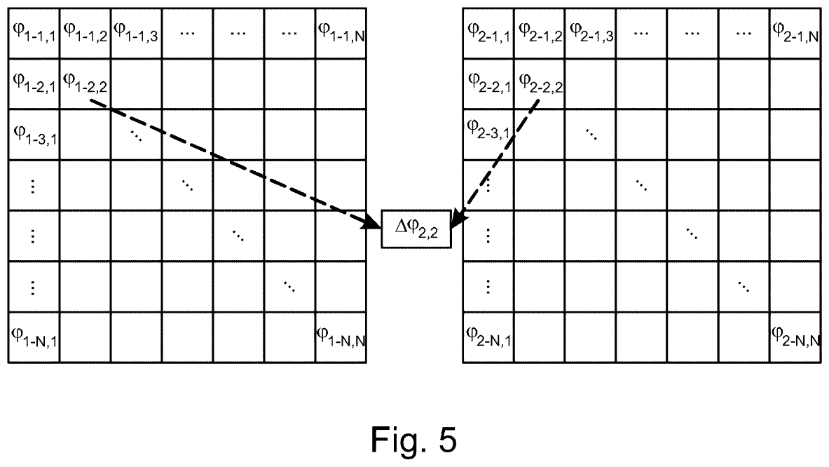

FIG. 5 shows two matrices with phase information or image phases per pixel for a 2D reconstruction at the estimated distance ds for two frequency sampling points, wherein the left-hand matrix shows the image phases for the frequency sampling point with the frequency f1, and the right-hand matrix shows the image phases for the frequency sampling point with the frequency f2.

For each pixel of the estimated locating or the estimated shell, the correlation is performed and summed over all the transmitting/receiving combinations. Thus, two complex radar images result in the case of two different frequencies f₁ and f₂. By forming the difference phase ΔΦ of the two images and with the aid of the known frequency difference Δf=f₂−f₁, Δd can be calculated, provided it is located at a target on the corresponding pixel, and thus the exact distance of the shell from the radar can be calculated for each pixel, as is shown in the following formula.

$$Δ d = \frac{c \cdot Δ ϕ}{4 \cdot π \cdot Δ f}$$

In the case of use of at least two frequency sampling points, for example according to the FSK MIMO principle, on the side of the primary modality 20, by which a spatially resolved image of the shell is generated, this image is subsequently compared with the data of the assisting modality and optionally complemented and finely adjusted. This step is omitted in the case of use of just one frequency. At this point, in particular the use of different wavelengths, for example the combination of a radar-based primary modality 20 and an optical assisting modality 30, an image of different boundary surfaces of the shell can be generated, since for example the radar can penetrate material such a clothing or cardboard, but an optical measuring system cannot.

Finally, a new data pool is achieved by a described measuring setup of the two modalities 20 and 30 and the above-explained method for sensor data fusion, which data pool comprises, as information per measuring cycle, as precise as possible a spatially resolved image of the shell, including spatially distributed velocity information.

The preprocessing methods explained above initially only provide data for individual measuring cycles. Postprocessing methods building on these estimate the continuous movement of the recorded shell over a longer time period. As has been set out above, in the case of the methods hitherto, in optical imaging technology, preferably spatially resolved, direct velocity information cannot be obtained. Therefore, in the case of postprocessing methods for estimating the velocity, the quality is significantly influenced by the measuring rates of the optical measuring system or the assisting modality 30. In order to be able to temporally track the movement, preferably initially correspondences are found between two consecutive images, in order to thereupon be able to estimate the movement pattern of these individual correspondences. The greater the spacing between the individual measuring cycles of the modality used, the greater the search space in order to find the correspondences and thus to ascertain the movement that has taken place therebetween.

The availability of additional velocity information now makes it possible for said search space to be dramatically reduced, and the correspondences to thus be ascertained more quickly and more accurately.

Further approaches for reducing the search space include for example the use of application-related models, which assess in advance both the shell and the movement of the recorded object 10.

In addition, the use of suitable statistical methods, for example a Kalman filter, makes it possible for the initially estimated velocity information to be subsequently corrected.

As well as additional velocity information, in particular the imaging of a plurality of boundary surfaces by the combination of a radar-based and an optical measuring system can be advantageous, if the recorded object 10 comprises a plurality of shells that move differently.

This is the case for example when assessing the movement of the shell of a person, since in this case an additional layer of clothing would hide the movements of the human body in the case of an optical measuring system.

Preferably, the described methods allow precise, high-performance determination of the movement of the shell of any object which has potential for real-time capability.

The methods can preferably be applied in the field of diagnosis and therapy in medicine or in the field of care, and in the fitness or sport domain, to the movement of the human body, since, as already mentioned, as well as the additional velocity information further advantages also result in the sensor image fusion. It is furthermore conceivable for the method to be used for generating a digital human avatar.

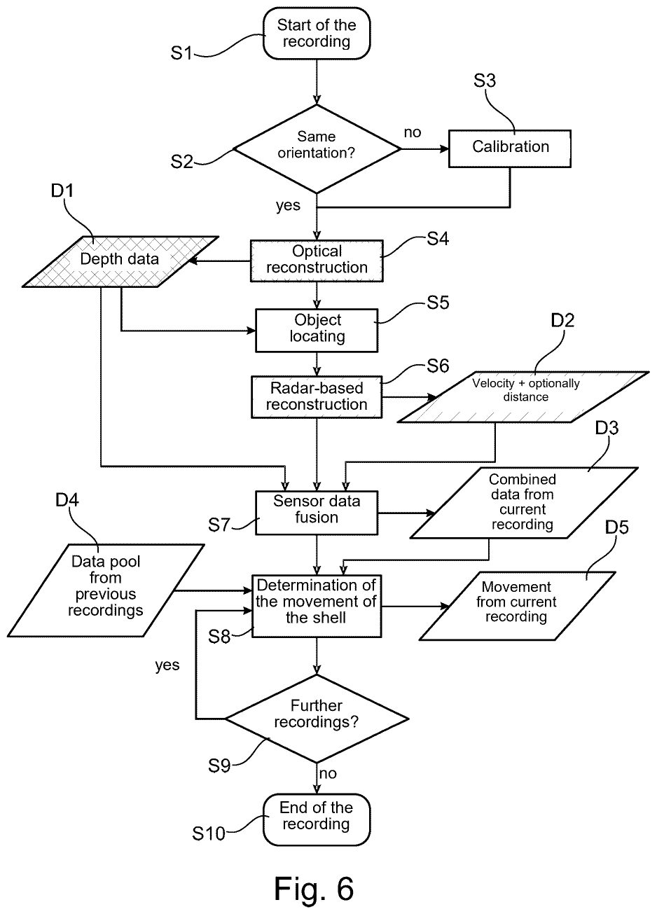

FIG. 6 shows an overview in the form of a flow diagram of a preferred method for operating a preferred configuration.

First, the recording is begun with step S1. Then, in step S2, a query is performed as to whether the modalities have the same orientation. If not, a calibration is performed with step S3. After the calibration or when the modalities have the same orientation, in step S4 the assisting modality performs an optical reconstruction of the object or the shell. In this case, depth data D1 are generated. These depth data are used in step S5 for locating the object or the shell. In step S6, the primary modality performs a radar-based reconstruction of the object or the shell. This results in data D2 with the velocity and/or the distance of the object or the shell. In step S7, the data D1 and D2 are merged in the course of sensor data fusion. This leads to combined data D3 from the current recording. In step S8, the movement of the object or the shell is determined. In this case, the data D3 and the data D4 from a previous recording serve as input data, on the basis of which the data D5 are generated relating to the movement of the object or the shell from the current recording. A query is performed, with step S9, as to whether further recordings exist. If further recordings exist, step S8 is repeated. If no further recordings exist, the recording is ended with step S10.

1. System for ascertaining a feature of an object, wherein the system has a primary modality, an assisting modality, and a controller, wherein the primary and the assisting modality are configured to in each case detect the feature, generate measurement data with respect to the feature, communicate with the controller which is configured for this purpose, be actuated by the controller which is configured for this purpose, and transmit the measurement data to the controller which is configured for this purpose, wherein the controller has means which are configured to actuate the primary modality such that the measurement data generated by the assisting modality are taken into consideration, and the controller has means which are configured to ascertain the feature of the object from the totality or from a part of the totality of the generated measurement data.

2. System according to claim 1, wherein the feature of the object relates to the shell of the object and/or that the object is a living creature and/or that the feature of the object is a position, velocity and/or acceleration of a region of the object or the shell of the object, and/or an item of phase information of a wave reflected from a region of the object or of the shell of the object.

3. System according to claim 1, wherein the controller comprises means which are configured to store the measurement data.

4. System according to claim 1, wherein the controller comprises means which are configured to compare a plurality of ascertained features and/or generated measurement data and to thereby determine a comparative value from which a further feature is derived.

5. System according to claim 1, wherein the primary modality comprises a radar system having at least one transmitting antenna and at least one receiving antenna.

6. System according to claim 5, wherein the antennas of the radar system form a MIMO aperture, wherein means are present which are configured for generating a laterally focused image of the object by aperture synthesis.

7. System according to claim 1, wherein the primary modality comprises a CW, stepped-frequency and/or frequency-shift keying radar system.

8. System according to claim 1, wherein the assisting modality comprises an optical measuring system.

9. System according to claim 1, wherein the controller comprises means which are configured to optimise the ascertainment of the feature of the object by means of features and/or measurement data.

10. System according to claim 1, wherein the controller comprises means which are configured to use a static filter, and/or that the means are configured such that a vectorial velocity measurement takes place.

11. System according to claim 1, wherein the system is a component of a sport, training or fitness measuring or fitness information system, that the system is used for a medical, psychological, diagnostic or therapeutic purpose and/or is used for generating digital human avatars.

12. Method for ascertaining a feature of an object using a system according to claim 1, having the steps of:
a) detecting the feature by means of the assisting modality, and generating measurement data with respect to the feature;
b) detecting the feature by means of the primary modality, wherein the primary modality is actuated by the controller in such a way that the measurement data generated in step a) are taken into account, and generating measurement data with respect to the feature;
c) ascertaining the feature from the measurement data.

13. Method according to claim 12, wherein the feature of the object relates to the shell of the object and/or the object is a living creature and/or that the feature of the object is a position, velocity and/or acceleration of a region of the object or the shell of the object, and/or an item of phase information of a wave reflected from a region of the object or of the shell of the object.

14. Method according to claim 12, wherein the generated measurement data are stored.

15. Method according to claim 12, wherein the method is performed again, wherein the ascertained feature and/or the generated measurement data from the first performance is compared with the ascertained feature and/or with the generated measurement data from the second performance, and wherein as a result a comparative value is determined, from which a further and/or improved feature is derived.

16. Method according to claim 12, wherein the primary modality transmits waves having fewer than 10 different frequency sampling points, from a transmitting antenna.

17. Method according to claim 12, wherein the method comprises a further step wherein a laterally focused image of the object is generated.

18. Method according to claim 12, wherein the method is performed again and a feature and/or measurement data from a preceding performance are used for optimising the performance.

19. Method according to claim 12, wherein in the method a static filter, and/or that a vectorial velocity measurement takes place.

20. Method according to claim 12, wherein the method is used in a sport, training or fitness measuring or fitness information system, or for a medical, psychological, diagnostic or therapeutic purpose, and/or for generating digital human avatars.

21. (canceled)

22. (canceled)
